(19) United States
(12) Patent Application Publication
(10) Pub. No.: US 2010/0105831 A1
(43) Pub. Date: Apr. 29, 2010

(54) MOISTURE-CURING HOT-MELT ADHESIVE WITH GOOD ADHESION

(75) Inventors: Gabriele Brenner, Duelmen (DE); Rene Koschabek, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, Essen (DE)

(21) Appl. No.: 12/595,046

(22) PCT Filed: May 20, 2008
(86) PCT No.: PCT/EP2008/056167

§ 371 Date: Oct. 8, 2009

(30) Foreign Application Priority Data
Jul. 17, 2007 (DE) 10 2007 033 651.0

(51) Int. Cl. C08L 67/00; C08G 63/02

(52) U.S. Cl. 524/601; 528/272; 525/418

(57) ABSTRACT

The present invention relates to the use of polyesters based on dicarboxylic acids having an odd carbon number and polyols having an odd carbon number as or in adhesives. The present invention further provides adhesives containing the stated polyesters, and also their use for producing bonds.

The present invention relates to the use of polyesters based on dicarboxylic acids having an odd carbon number and polyols having an odd carbon number as or in adhesives. The present invention further provides adhesives containing the stated polyesters, and also their use for producing bonds.

Within the adhesives industry, moisture-curing hot-melt adhesives constitute a significant product group which has for years seen strong growth. They offer the advantages of being free from solvents, of being able to be applied under hot conditions with low viscosity, and of cooling to develop a high initial strength which permits the rapid further-processing of the bonded substrates. After the reactive groups have cured with moisture, the bonds exhibit very high thermal shear resistance.

In order to ensure diverse utility it is necessary for the reactive hot-melt adhesive to exhibit a broad adhesion spectrum. Particularly in the case of difficult-to-bond substrates, such as acrylonitrile-butadiene-styrene (ABS), PMMA (polymethyl methacrylate), polyamide (PA) and aluminium, for example, the adhesion in the case of the existing reactive hot-melt adhesives is inadequate.

EP 0 340 906 describes quick-setting polyurethane adhesives which are composed of a mixture of at least two amorphous prepolymers characterized by different glass transition temperatures. The first polyurethane prepolymer has a glass transition temperature above room temperature and the second polyurethane prepolymer has a glass transition temperature below room temperature. The prepolymer having the higher glass transition temperature is composed preferably of a polyesterdiol and a polyisocyanate. The polyesterdiol may be a copolymer of aromatic acids (such as isophthalic acid or terephthalic acid) and/or aliphatic acids (such as adipic acid, azelaic acid or sebacic acid) and low molecular weight diols (such as ethylene glycol, butanediol, hexanediol). The prepolymer having the lower glass transition temperature is composed of a polyester which is linear or has a low degree of branching, a polyether or another OH-terminated polymer and polyisocyanate. Specialty polyesters such as polycaprolactones or polycarbonates can also be used.

DE 38 27 224 A describes moisture-curing isocyanate-functional hot-melt adhesives featuring a particularly high setting rate. Essential to the invention in that case is the use of polyesters whose backbone is preferably purely aliphatic and which contain from at least 12 up to a maximum of 26 methylene groups in the repeating unit formed from diol and dicarboxylic acids, the dicarboxylic acids used having 8-12 methylene groups. It is critical that decanedioic acid, dodecane-dioic acid or tetradecanedioic acid be present. Optionally the aliphatic dicarboxylic acids may be replaced up to 80 mol % by aromatic dicarboxylic acids. The nature of the aliphatic diols is arbitrary per se, but diols having 6 to 12 methylene groups are preferred. The adhesive can be used to bond various substrates such as metal, glass, paper, ceramic, leather or plastics.

EP 0 455 400 describes a mixture of isocyanate-terminated polyurethane prepolymers. The first prepolymer is based on polyhexamethylene adipate, the second on polytetramethylene ether glycol. The adhesive is said to adhere well to plastics. A disadvantage of the adhesive is the poor adhesion to metal.

EP 568607 describes a mixture of isocyanate-terminated polyurethane prepolymers. The first prepolymer is a reaction product of a predominantly semi-crystalline polyester and a polyisocyanate. The polyester is a reaction product of a diol having 2 to 10 methylene groups and a dicarboxylic acid having 2 to 10 methylene groups. Diols may be ethylene glycol, butane-1,4-diol, pentane-1,5-diol, hexane-1,6-diol, octane-1,8-diol, decane-1,10-diol, cyclohexane-1,4-diol, cyclohexane-1,4-dimethanol and mixtures thereof. Dicarboxylic acids may be succinic acid, glutaric acid, adipic acid, sebacic acid, azelaic acid, dodecanedioic acid and mixtures thereof. Preference is given to polyesters formed from hexane-1,6-diol and adipic acid. The second prepolymer contains a reaction product of a polytetramethylene ether glycol and a polyisocyanate. The third prepolymer is based on a reaction product of an amorphous polyester and a polyisocyanate. The amorphous polyester contains aromatic structural units. Preferred diols are ethylene glycol, propylene glycol, butanediol, hexanediol, cyclohexanedimethanol, neopentyl glycol and mixtures thereof. The dicarboxylic acids are selected from the group consisting of succinic acid, adipic acid, sebacic acid, isophthalic acid, orthophthalic acid, terephthalic acid and mixtures thereof. The mixture may also contain a fourth prepolymer composed of a reaction product of a branched polyester formed from adipic acid, diethylene glycol and trimethylolpropane with a polyisocyanate. The higher molecular weight is said to increase significantly the tack and cohesion. A disadvantage is the high viscosity. The adhesive is said to adhere well to metals and polymeric substrates such as polystyrene or polymethyl methacrylate.

U.S. Pat. No. 6,221,978 describes a moisture-curable polyurethane adhesive which is composed of an epoxy resin and a polyurethane prepolymer. The polyurethane prepolymer is a reaction product of a polyol and a polyisocyanate. The polyol is a reaction product of aromatic dicarboxylic acids, optionally comonomer dicarboxylic acids and diols. Comonomer acids specified include dodecanedioic acid, succinic acid, glutaric acid, adipic acid, azelaic acid, sebacic acid, octadecanedicarboxylic acid, 1,4-cyclohexanedicarboxylic acid, dimer fatty acids and fumaric acid. In one particular embodiment the aromatic dicarboxylic acid is isophthalic acid and the comonomer acid is adipic acid. Diols specified include ethylene glycol, propane-1,2-diol, propane-1,3-diol, butane-1,3-diol, pentane-1,5-diol, hexane-1,4-diol, hexane-1,6-diol, decane-1,10-diol, neopentyl glycol, diethylene glycol, polyethylene glycol, dipropylene glycol, polypropylene glycol, 1,4-cyclohexanedimethanol, 1,4-cyclohexanediol, bis-phenol A units and mixtures thereof. A preferred diol is hexane-1,6-diol. It is critically important that the aromatic dicarboxylic acid be free from phthalic acid. In one embodiment the adhesive additionally contains crystalline polyesterpolyols, in order to increase the initial strength. The crystalline polyesterpolyol is composed of a reaction product of an aliphatic diol having 2 to 10 methylene groups and an aliphatic dicarboxylic acid having 2 to 10 methylene groups. Suitable diols are ethylene glycol, butane-1,4-diol, pentane-1,5-diol, hexane-1,6-diol, octane-1,8-diol, decane-1,10-diol, 1,4-cyclohexanediol and 1,4-cyclohexanedimethanol. Suitable aliphatic dicarboxylic acids are succinic acid, glutaric acid, adipic acid, sebacic acid, dodecanedioic acid, dimer fatty acids and mixtures thereof. In one particular embodiment the crystalline polyesterpolyol is composed of hexanediol and dodecanedioic acid. The adhesive may also contain flexible and amorphous polyesters formed from hexanediol, butanediol, neopentyl glycol, ethylene glycol, diethylene glycol, propylene glycol or 2-methylpropanediol and adipic acid, isophthalic acid or terephthalic acid. The adhesive is used for the bonding of difficult-to-bond substrates having a low surface energy. The epoxy resin is said to increase the adhesion to polyethylene, polypropylene and metals. It is critically important that the aromatic dicarboxylic acid be free from phthalic acid.

US 2003/0144454 describes polyurethane compositions based on polyester block copolymers and polyisocyanates. The polyester block copolymers are composed of polyethers, polybutadiene, polycarbonate or polycaprolactone and a polyester. The polyester structural unit of the block copolymer is composed preferably of C₆-C₁₄ dicarboxylic acids and C₄-C₁₂ diols. Dicarboxylic acids and diols having an even number of carbon atoms are preferred. The adhesive may optionally contain reaction products of polyisocyanates and polyesterpolyols and/or polyetherpolyols. The adhesive based on polyester block copolymers is suitable for bonding a diversity of substrates, especially metallic substrates and plastics. The disadvantage of this adhesive is the cost and complexity of preparing the block copolymer.

The object was to develop moisture-crosslinking hot-melt adhesives which are able to ensure further-improved adhesion to difficult-to-bond substrate surfaces. Surprisingly the object is achieved through the provision of an adhesive, more particularly a hot-melt adhesive, in accordance with the claims.

The present invention first provides, accordingly, the use of polyesters based on dicarboxylic acids having an odd carbon number and polyols having an odd carbon number as or in adhesives. It has surprisingly emerged that the polyesters used in accordance with the invention lead to particularly good bonds, something which could not have been foreseen from the prior art.

The polyesters selected specifically in accordance with the invention are based on dicarboxylic acids having an odd carbon number, in other words having 2n−1 (n=1, 2, 3 . . . ) methylene groups. The dicarboxylic acids are preferably linear. “Linear” in the sense of the present invention means that the functional groups, the carboxyl functions for example, are located on the terminal carbon atoms of the longest carbon chain.

Examples of suitable linear dicarboxylic acids are malonic acid, glutaric acid, pimelic acid, azelaic acid, undecanedioic acid, tridecanedioic acid and pentadecanedioic acid.

In principle the dicarboxylic acids having an odd carbon number may be aliphatic or aromatic.

In one particularly preferred embodiment the dicarboxylic acids are aliphatic; more particularly they are linear aliphatic dicarboxylic acids, and with very particular preference they are dicarboxylic acids from the group consisting of glutaric acid, pimelic acid, azelaic acid, undecanedioic acid, tridecanedioic acid and pentadecanedioic acid, with preference being given in turn to azelaic acid and undecanedioic acid.

With regard to the polyols having an odd carbon number, i.e. having 2n−1 (n=1, 2, 3 . . . ) carbon atoms, there are in principle no restrictions. Preferably the polyols are linear and unbranched, the definition of “linear” given for the dicarboxylic acids also applying to the polyols.

“Unbranched” in the sense of the present invention means that there are no side chains and that the C atoms are present in the form of CH₂ groups.

With particular preference the polyols are linear, aliphatic and unbranched and are selected more particularly from the group consisting of 1,3-propane-diol, 1,5-pentanediol, 1,7-heptanediol, 1,9-nonanediol, 1,11-undecanediol and 1,13-tridecanediol, very particular preference being given to 1,3-propanediol and 1,5-pentanediol.

In particular the polyesters are based on linear, aliphatic dicarboxylic acids, and on linear aliphatic diols. Surprisingly it has been found that with hydroxyl polyesters which contain linear aliphatic dicarboxylic acids having an odd number of carbon atoms and linear aliphatic diols having an odd number of carbon atoms, it is possible to improve the adhesion to difficult-to-bond substrates such as aluminium, ABS, PMMA or PA.

The polyesters used in accordance with the invention, also called hydroxyl polyesters, possess more than one OH group, and with very particular preference they are difunctional. Hydroxyl polyesters in the sense of the invention have OH numbers of 5-150, preferably of 10-50. The hydroxyl number (OH number) is determined in accordance with DIN 53240-2. In the case of that method the sample is reacted with acetic anhydride in the presence of 4-dimethylaminopyridine as catalyst, and in this reaction the hydroxyl groups are acetylated. This produces one molecule of acetic acid per hydroxyl group, while the subsequent hydrolysis of the excess acetic anhydride yields two molecules of acetic acid. The consumption of acetic acid is determined titrimetrically from the difference between the main value and a blank value which is to be carried out in parallel. The polyesters used in accordance with the invention preferably have acid numbers of below 10, more preferably below 5 and very preferably below 2. The acid number is determined in accordance with DIN EN ISO 2114. The acid number (AN) is the amount of potassium hydroxide, in mg, which is needed to neutralize the acids present in one gram of substance. The sample under analysis is dissolved in dichloro-methane and is titrated with 0.1 N methanolic potassium hydroxide solution against phenolphthalein.

The number-average molecular weight of the polyesters of the invention is 700-22 000 g/mol, preferably 2000-10 000 g/mol. The molecular weight is determined by means of gel permeation chromatography (GPC). The samples are characterized in tetrahydrofuran as eluent in accordance with DIN 55672-1.

Mₙ(UV)=number−average molar weight (GPC,UV detection), reported in g/mol

M_{w}(UV)=mass−average molar weight (GPC,UV detection), reported in g/mol

The melting point of the hydroxyl polyesters used in accordance with the invention is in the range of 20° C.-125° C., preferably of 30° C.-100° C. and very preferably in a range of 35° C.-80° C.

The melting point is determined by the DSC method, DIN 53765.

In a further embodiment of the present invention the dicarboxylic acids having an odd carbon number may be partly replaced by dicarboxylic acids having an even carbon number. The dicarboxylic acids having an even carbon number may be aliphatic and/or cycloaliphatic polycarboxylic, preferably dicarboxylic, acids having an even carbon number. Dimer fatty acids are also suitable for replacing the dicarboxylic acids of the invention having an odd carbon number. The fraction of the dicarboxylic acids having an odd carbon number is 5-100 mol %, preferably 20-100 mol % and very preferably 50-100 mol %, based on the total amount of dicarboxylic acids. In a very preferred way there are no further dicarboxylic acids present besides the dicarboxylic acids having an odd carbon number.

Examples of aliphatic polycarboxylic acids having an even carbon number are succinic acid, adipic acid, sebacic acid, dodecanedioic acid, tetradecanedioic acid, hexadecanedioic acid and octadecanedioic acid. Examples of cycloaliphatic dicarboxylic acids are the isomers of cyclohexanedicarboxylic acid. If desired it is also possible in place of the free acids to use their esterifiable derivatives, such as corresponding lower alkyl esters or cyclic anhydrides, for example.

In further embodiments in accordance with the present invention the dicarboxylic acids having an odd carbon number may be replaced by aromatic polycarboxylic acids, preferably dicarboxylic acids, the fraction of the dicarboxylic acids having an odd carbon number in the polyesters being 5-100 mol %, preferably 20-100 mol % and very preferably 50-100 mol %, based on the total dicarboxylic acid content. If desired it is additionally possible for there to be even-numbered aliphatic and/or cycloaliphatic polycarboxylic acids and/or dimer fatty acids present besides the aromatic polycarboxylic acids.

Examples of aromatic polycarboxylic acids are terephthalic acid, isophthalic acid, phthalic acid, naphthalenedicarboxylic acid, trimellitic acid and pyromellitic acid. In place of the free polycarboxylic acids it is also possible to use their esterifiable derivatives, such as corresponding lower alkyl esters or cyclic anhydrides, for example.

In a further embodiment of the present invention the polyols having an odd carbon number may be partly replaced by polyols having an even carbon number and/or by branched polyols. The polyols having an even carbon number or the branched polyols may be aliphatic, cyclo-aliphatic and/or aromatic polyols, preferably diols. On the diol side the fraction of the polyols having an odd carbon number is 5-100 mol %, preferably 20-100 mol % and very preferably 50-100 mol %, based on the total amount of polyols.

Examples of polyols having an even carbon number, or of branched polyols, are ethylene glycol, propane-1,2-diol, butane-1,4-diol, hexane-1,6-diol, dodecane-1,12-diol, neopentyl glycol, butylethylpropane-1,3-diol, methylpropanediol, methylpentanediols, cyclohexanedi-methanols, trimethylolpropane, pentaerythritol and mixtures thereof. By aromatic polyols are meant reaction products of aromatic polyhydroxy compounds such as hydroquinone, bisphenol A, bisphenol F, dihydroxynaphthalene, etc., for example, with epoxides such as ethylene oxide or propylene oxide, for example. As polyols it is also possible for etherdiols to be present, i.e. oligomers and/or polymers, based for example on ethylene glycol, propylene glycol or butane-1,4-diol. Particular preference is given to linear aliphatic glycols.

Besides polyols and polycarboxylic acids it is also possible to use lactones for the synthesis of the hydroxyl polyesters.

The polyesters employed in accordance with the invention are preferably crystalline. The stated hydroxyl polyesters which possess dicarboxylic acids having an odd number of carbon atoms and diols having an odd number of carbon atoms are prepared by means of established techniques for condensation reactions. For these reactions, any desired polyols and the polycarboxylic acid(s) of the invention or, if desired, the said acid(s) in a mixture with other (cyclo-)aliphatic and/or aromatic polycarboxylic acids and/or their esterifiable or transesterifiable derivatives are used, the ratio of hydroxyl group to carboxyl group equivalents being 1.02 to 1.5, preferably 1.05 to 1.3. The (poly)condensation takes place at temperatures from 150° C. to 270° C. within from 3 to 30 h, it being possible to operate with reduced pressure following elimination of the major part of the theoretically calculated quantity of water. Selectively it is also possible to operate with addition of catalysts for the purpose of accelerating the (poly)condensation reaction and/or azeotrope formers for the purpose of separating off the water of reaction. Typical catalysts are organotitanium or organotin compounds, such as tetrabutyl titanate or dibutyltin oxide, for example. The catalysts may be charged selectively at the beginning of the reaction, with the other starting materials, or not until later, during the reaction. Azeotrope formers which can be used include, for example, toluene or various solvent naphtha grades. Selectively the hydroxyl polyesters can be furnished without or with operational assistants or additives such as antioxidants, for example.

The present invention further provides adhesives containing polyesters based on dicarboxylic acids having an odd carbon number and polyols having an odd carbon number. In principle the adhesives of the invention may be any kind of adhesives known to a person skilled in the art; more particularly they are melt-applied adhesives (hot-melts). With very particular preference the hot-melt adhesives are reactive hot-melts (RHM), more particularly moisture-crosslinking hot-melt adhesives.

In particular the moisture-crosslinking hot-melt adhesives of the invention further contain isocyanates and/or polyisocyanates. In the adhesives the OH:NCO ratio of polyester to isocyanate and/or polyisocyanate is 1:1.2 to 1:3, preferably from 1:1.5 to 1:2.5.

The polyisocyanates may be difunctional and/or poly-functional aromatic, aliphatic and/or cycloaliphatic isocyanates. Aromatic polyisocyanates are particularly preferred. Examples of polyisocyanates are 4,4′-diphenylmethane diisocyanate, 2,4′-diphenylmethane diisocyanate, toluene diisocyanate isomers, isophorone diisocyanate, hexamethylene diisocyanate, 4,4′-dicyclo-hexylmethane diisocyanate and mixtures thereof. More particularly the compounds in question are 4,4′-diphenylmethane diisocyanate and mixtures of 4,4′-diphenylmethane diisocyanate and 2,4′-diphenylmethane diisocyanate.

In the reactive hot-melt adhesives the fraction of the hydroxyl polyesters of the invention is 1%-99% by weight, and preferably 1%-70% by weight.

In preferred embodiments, in addition to the hydroxyl polyesters of the invention, there are also other polyols present in the hot-melt adhesives, including, for example, polyesterpolyols, polyetherpolyols and any desired hydroxyl-functional components.

The admixed polyesterpolyols may be liquid and/or solid, amorphous and/or (partly)crystalline polyesters of any desired structure, having molecular weights Mn between 1000 g/mol and 30 000 g/mol, preferably between 2000 g/mol and 10 000 g/mol (calculated from the hydroxyl number), preference being given to the use of linear polyesterpolyols. The admixed polyetherpolyols are polyetherdiols and -triols. Examples thereof are homopolymers and copolymers of ethylene glycol, propylene glycol and butane-1,4-diol. The molecular weight Mn of the admixed polyetherpolyols ought to be situated within a range from 200 g/mol to 10 000 g/mol, preferably between 400 g/mol and 6000 g/mol.

Examples of any desired hydroxy-functional components are functionalized (H-acidic), thermoplastic polyurethanes (TPU) and/or polyacrylates and/or ethylene-vinyl acetate copolymers (EVA).

The hot-melt adhesives of the invention may contain up to 50% by weight of further additions. These additions may be as follows: non-functionalized polymers, e.g. thermoplastic polyurethanes (TPU) and/or polyacrylates and/or ethylene-vinyl acetate copolymers (EVA); pigments and/or fillers, e.g. talc, silicon dioxide, titanium dioxide, barium sulphate, calcium carbonate, carbon black or coloured pigments; tackifiers, such as rosins, hydrocarbon resins and phenolic resins, for example, and also ageing inhibitors and assistants.

The adhesives of the invention are suitable in a particular way for producing bonds. More particularly the hot-melt adhesives of the invention are suitable for bonding a multiplicity of substrates, more particularly for bonding metallic substrates, and very particularly for bonding various plastics. The nature and the scope of the adhesive bonding are not limited. The bonds in question are preferably bonds in the wood and furniture industries (assembly bonding, for example), in the automotive sector (retainer bonds, for example), in the construction industry, shoe industry and textile industry, and also in window construction (for profile wrapping, for example). Additionally the adhesives of the invention are suitable in the packaging industry and as sealants.

Even without further statements it is assumed that a person skilled in the art will be able to utilize the above description to its widest extent. Consequently the preferred embodiments and examples are to be interpreted merely as a descriptive disclosure which in no way has any limiting effect whatsoever. Below, the present invention is illustrated in more detail with reference to examples. Alternative embodiments of the present invention are obtainable in a similar way.

### EXAMPLES

### Preparation of Hydroxyl Polyesters

### Inventive Example a

Tridecane-1,13-dioic acid (244 g, 1.0 mol) and pentane-1,5-diol (132 g, 1.1 mol) are melted in a stream of nitrogen in a 1 l flask with distillation attachment. When a temperature of 160° C. is reached, water begins to be distilled off. Over the course of an hour the temperature is raised successively to 240° C. After a further hour at this temperature, the elimination of water slows down. 50 mg of titanium tetrabutoxide are incorporated with stirring, and operation continues under reduced pressure, which is adjusted in the course of the reaction in such a way that distillate continues to be produced. When the desired hydroxyl number and acid number ranges have been reached, the system is shut down. The hydroxyl number, acid number and melting point are determined as reported in Table 1, and are found to be 29 mg KOH/g, 0.6 mg KOH/g and 64° C. The syntheses of the hydroxyl polyesters in Inventive Examples b-f and in Comparative Examples Ca-Cc take place in a manner comparable to that of Inventive Example a, using the diols and dicarboxylic acids specified in Table 1.

TABLE 1
Composition of the base polyesters (in mol %) and their properties

| Polyester composition | | | | | | | | | | Polyester | | |
|---|---|---|---|---|---|---|---|---|---|---|---|---|
| Acid component | | | | | | Alcohol component | | | | properties | | |
| AZ | UD | TD | SB | AD | DD | PG | PD | BD | HD | OHN | AN | m.p. |

Inv. ex.

| | | | | | | | | |
|---|---|---|---|---|---|---|---|---|
| a | | | 100 | | 100 | 29 | 0.6 | 64 |
| b | | 100 | | 100 | | 30 | 1.0 | 67 |
| c | | | 100 | 100 | | 30 | 0.3 | 75 |
| d | | 100 | | | 100 | 31 | 0.4 | 58 |
| e | 100 | | | 100 | | 30 | 0.4 | 51 |
| f | 100 | | | | 100 | 30 | 0.8 | 49 |

Comparative examples

| | | | | | | | | |
|---|---|---|---|---|---|---|---|---|
| Ca | | | 100 | 100 | | 30 | 0.2 | 68 |
| Cb | 100 | | | 100 | | 30 | 0.5 | 62 |
| Cc | | 100 | | | 100 | 30 | 0.7 | 55 |

AD = adipic acid
AZ = azelaic acid
DD = dodecanedioic acid
TD = tridecanedioic acid
UD = undecanedioic acid
SB = sebacic acid
BD = butane-1,4-diol
HD = 1,6-hexanediol
PG = 1,3-propanediol
PD = 1,5-pentanediol
OHN = hydroxyl number, reported in mg KOH/g, measured to DIN 53240-2
AN = acid number, reported in mg KOH/g, measured to DIN EN ISO 2114
m.p. = melting point, reported in ° C., DSC method, 2nd heating

### Preparation and Characterization of Moisture-Curing Hot-Melt Adhesives

The moisture-curing hot-melt adhesives (RHM) described in the examples below are characterized for their melt viscosity at 130° C. (Brookfield Thermosel, spindle no. 27), their softening point (ring & ball) to DIN ISO 46 and their bond strength to DIN EN 1465.

### Inventive Example RHM 1

In a 500 ml flask with ground-glass connections, 35 parts by weight of DYNACOLL 7130, 25 parts by weight of DYNACOLL 7230 and 40 parts by weight of hydroxyl polyester e are melted and dried under reduced pressure at 130° C. Thereafter 4,4′-diphenylmethane diisocyanate (MDI) is added in a molar OH/NCO ratio of 1/2.2 and rapidly homogenized. For the complete reaction of the reactants the mixture is stirred under an inert gas atmosphere at 130° C. for 45 minutes. Subsequently the moisture-curing hot-melt adhesive is discharged. The resulting hot-melt adhesive possesses a melt viscosity (130° C.) of 7 Pa·s. The softening point (ring & ball) is 45° C. The bond strength, after a cure time of seven days at 20° C. and 65% relative humidity, is 5 N/mm² on aluminium, 8 N/mm² on ABS, 6 N/mm² on polyamide and 6 N/mm² on PMMA.

### Comparative Example RHM 2

Implementation takes place in the same way as for Inventive Example RHM 1, the hydroxyl polyester e being replaced by hydroxyl polyester Cc. The resulting hot-melt adhesive possesses a melt viscosity (130° C.) of 5 Pa·s. The softening point (ring & ball) is 55° C. The bond strength, after a cure time of seven days at 20° C. and 65% relative humidity, is 3 N/mm² on aluminium, 5 N/mm² on ABS, 3 N/mm² on polyamide and 2 N/mm² on PMMA.

Comparison of the two preceding examples shows the significantly improved adhesion when using the polyesters of the invention.

### RHM 3-9

Implementation takes place in the same way as for Inventive Example RHM 1, in accordance with the compositions indicated in Table 2.

TABLE 2
Properties of moisture-curing hot-melt adhesives based on
mixtures of polyols and 4,4′-MDI (OH:NCO ratio 1:2.2)

| | | | | | | | | | |
|---|---|---|---|---|---|---|---|---|---|
| RHM | 1 | 2 | 3 | 4 | 5 | 6 | 7 | 8 | 9 |

| | | | | | | | | | |
|---|---|---|---|---|---|---|---|---|---|
| Composition | | | | | | | | | |
| DYNACOLL 7130 | 35 | 35 | 35 | 35 | 35 | 35 | 35 | 35 | 35 |
| DYNACOLL 7230 | 25 | 25 | 25 | 25 | 25 | 25 | 25 | 25 | 25 |
| Hydroxyl polyester a | | | | | | | | | 40 |
| Hydroxyl polyester b | | | 40 | | | | | | |
| Hydroxyl polyester c | | | | | | 40 | | | |
| Hydroxyl polyester d | | | | | | | 40 | | |
| Hydroxyl polyester e | 40 | | | | | | | | |
| Hydroxyl polyester f | | | | 40 | | | | | |
| Hydroxyl polyester Ca | | | | | | | | 40 | |
| Hydroxyl polyester Cb | | | | | 40 | | | | |
| Hydroxyl polyester Cc | | 40 | | | | | | | |
| RHM properties | | | | | | | | | |
| Viscosity | 7 | 5 | 6 | 5 | 7 | 13 | 8 | 10 | 17 |
| (130° C./Pa · s) | | | | | | | | | |
| s.p. (r&b) (° C.) | 45 | 55 | 65 | 45 | 63 | 75 | 60 | 75 | 64 |
| Bond strength (N/mm²) | | | | | | | | | |
| Aluminium | 5 | 3 | 6 | 4 | 4 | 7 | 5 | 4 | 4 |
| ABS | 8 | 5 | 8 | 8 | 3 | 7 | 7 | 4 | 6 |
| Polyamide | 6 | 3 | 4 | 7 | 1 | 3 | 3 | 1 | 3 |
| PMMA | 6 | 2 | 4 | 5 | 2 | 3 | 5 | 2 | 3 |

RHM 2, 5 and 8 are comparative examples
4,4′-MDI = 4,4′-diphenylmethane diisocyanate, e.g. Suprasec 1306 (Huntsman), Isonate M124 (Dow), Lupranat ME (BASF)
DYNACOLL 7130 is an amorphous polyester formed from C₂, C₅ and C₁₀ diols, adipic acid, terephthalic acid and isophthalic acid, from Degussa, having a glass transition temperature Tg = 30° C. and a hydroxyl number of 35 mg KOH/g.
DYNACOLL 7230 is a liquid polyester formed from C₂, C₅ and C₆ diols, adipic acid, terephthalic acid and isophthalic acid, from Degussa, having Tg = −30° C. and a hydroxyl number of 30 mg KOH/g.

The examples show that, with hydroxyl polyesters which contain linear aliphatic dicarboxylic acids having an odd number of carbon atoms and linear aliphatic polyols having an odd number of carbon atoms, it is possible to improve the adhesion to difficult-to-bond substrates such as aluminium, ABS, PMMA or PA.

1. A polyester comprising a dicarboxylic acid having an odd carbon number and a polyol having an odd carbon number.

2. The polyester according to claim 1, wherein the dicarboxylic acid is linear.

3. The polyester according to claim 1, wherein the dicarboxylic acid is aliphatic.

4. The polyester according to claim 1, wherein the polyol is linear.

5. The polyester according to claim 1, wherein the polyol is unbranched.

6. The polyester according to claim 1, wherein the polyester has an OH number of 5-150.

7. The polyester according to claim 1, wherein a molecular weight of the polyester is 700-22 000 g/mol.

8. The polyester according to claim 1, wherein a the melting point of the polyester is in the range of 20-125° C.

9. The polyester according to claim 1, wherein the dicarboxylic acid having an odd carbon number is replaced by a dicarboxylic acid having an even carbon number.

10. The polyester according to claim 1, wherein the polyol having an odd carbon number is replaced by a polyol having an even carbon number and/or by a branched polyol.

11. An adhesive comprising a polyester comprising a dicarboxylic acid having an odd carbon number and a polyol having an odd carbon number.

12. The adhesive according to claim 11, wherein the adhesive is a hot-melt adhesive.

13. The adhesive according to claim 11, wherein the adhesive further comprises an isocyanate and/or a polyisocyanate.

14. The adhesive according to claim 11, further comprising other polyols, non-functionalized polymers, pigments and/or fillers, tackifiers, ageing inhibitors and assistants.

15. A sealant comprising the adhesive according to claim 11.
